(19) United States
(12) Patent Application Publication
(10) Pub. No.: US 2003/0164673 A1
(43) Pub. Date: Sep. 4, 2003

(54) System and method for adhering a transparent panel to a cathode ray tube

(75) Inventors: David Allen Murtishaw, Sun City, CA (US); Akira Kondo, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(73) Assignee: Sony Corporation

(21) Appl. No.: 09/894,417

(22) Filed: Jun. 28, 2001

(51) Int. Cl. H01J 31/00

(52) U.S. Cl. 313/479

(57) ABSTRACT

A method and system for applying adhesive to a transparent, anti-reflective panel for a Cathode Ray Tube (“CRT”) include applying adhesive only around an outside perimeter of the panel. Preferably, the adhesive is only applied in the outermost perimeter of the panel which corresponds to the outer perimeter of the display surface of the CRT which is beyond the useable area of the display surface, i.e., where no portion of the images displayed extend. Thus, the adhesive will hold the transparent panel to the display surface of the CRT, but will not collect dust and other contaminants that will be trapped over the useable display area of the CRT. Additionally, the panel, with adhesive only around its perimeter, will be relatively easy to remove from the CRT for salvage and reclamation purposes.

### FIELD OF THE INVENTION

The present invention relates to the field of cathode ray tube manufacture. More particularly, the present invention relates to the process of adhering a transparent panel bearing an anti-reflective coating to the front of a cathode ray tube. The present invention provides novel means and method of applying an adhesive to the transparent panel only in the outer perimeter of the panel beyond the viewing area of the cathode ray tube.

### BACKGROUND OF THE INVENTION

Cathode ray tubes (“CRTs”) are used in most television sets and computer and video monitors. A typical CRT is illustrated in FIG. 1. The CRT (100) is a glass tube with a bottle-like shape in which a relatively flat bottom portion (101) narrows into an elongated neck portion (102). The relatively flat portion (101) of the CRT (100) becomes the screen on which the display of the television set or monitor is generated when the CRT is incorporated therein. This display surface (101) of the CRT (100) includes a central area (101v) which is the viewing area where images are displayed. The display surface (101) also includes a peripheral area or perimeter (101nv), around the viewing area (101v), into which the images displayed do not extend.

An electro-luminescent material, such as phosphorus, that emits light when struck by an electron beam, is coated over the interior of the screen portion (101) of the CRT (100). An electron gun (not shown) is then installed in the neck (102) of the CRT (100). A stream of electrons emitted from the electron gun is scanned over the electro-luminescent layer and turned on and off during the scanning to cause the electro-luminescent layer to glow in certain places and not others. In very simple terms, this is how an image is generated on the screen of a television or video monitor.

A yoke (not shown) is provided around the neck (102) of the CRT (100). This yoke produces a changing magnetic field through which the electron beam from the electron gun passes. The electron beam is deflected by the magnetic field of the yoke. Consequently, by varying the magnetic field created by the yoke in a precise cycle, the electron beam can be scanned, line-by-line, over the entire surface of the screen to generate video images thereon.

A cathode ray tube is generally constructed in the following matter. The neck (102) or funnel portion of the CRT (100) is formed open at both ends. Then the relatively flat display portion (101) is sealed to the large end of the funnel and the electron gun is installed in the narrow end or neck of the funnel.

The display portion (101) is sealed to the funnel (102) using frit. Frit is a glass paste that can be cured or hardened. Frit (103), in paste form, is applied around the large end of the funnel (102) between the funnel (102) and the display portion (101). The frit is then cured or hardened to form a frit seal (103) between the funnel (102) and the display portion (101).

To improve the display portion of the CRT (100), a transparent plastic panel (110), shown in FIG. 2, is adhered to the display surface (101) of the CRT (100). The plastic panel (110) has an anti-reflective coating (111) applied over one surface. This anti-reflective coating (111) prevents reflections that would otherwise distract a viewer and degrade the images displayed on the surface (101) of the CRT (100).

An adhesive layer (112) is applied over the entire opposite surface of the panel (110). This adhesive (112) is then used to adhere the panel (110) to the display surface (101) of the CRT (100).

While the anti-reflective coating (111) substantially improves the performance of the CRT (100), the process of adhering the panel (110) to the CRT (100) can introduce other problems. For example, dust and other contaminants tend to become stuck to the adhesive layer (112) on the panel (110) before the panel (110) is adhered to the CRT (100). These contaminants are then trapped between the panel (110) and the display surface (101) of the CRT (100). Such trapped contaminants degrade the quality of the image shown on the CRT (100).

Additionally, if the CRT (100) has to be disassembled for reclamation and salvage, it is very difficult to remove the panel (110) from the CRT (100). There are no ready means of accessing or dissolving the adhesive holding the center of the panel (110) to the CRT (100).

Consequently, there is a need in the art for an improved method and system of adhering the transparent panel to the front, display surface of a cathode ray tube so as to prevent the collection and entrapment of dust and other contaminants and to allow the relatively easy removal of the panel if the cathode ray tube must be disassembled for salvage or reclamation.

### SUMMARY OF THE INVENTION

The present invention meets the above-described needs and others. Specifically, the present invention provides an improved method and system of adhering the transparent panel to the front, display surface of a cathode ray tube so as to prevent the collection and entrapment of dust and other contaminants and to allow the relatively easy removal of the panel if the cathode ray tube must be disassembled for salvage or reclamation.

Additional advantages and novel features of the invention will be set forth in the description which follows or may be learned by those skilled in the art through reading these materials or practicing the invention. The advantages of the invention may be achieved through the means recited in the attached claims.

The present invention may be embodied and described as an anti-reflective, transparent panel for application to the display surface of a cathode ray tube. The transparent panel includes a strip of adhesive applied around an outer perimeter of the transparent panel and not in the central, viewing portion of the transparent panel. Preferably, the strip of adhesive covers approximately 15 percent of a surface of the transparent panel. The transparent panel is preferably glass, but may also be made of plastic.

To describe the transparent panel of the present invention further, the transparent panel includes a non-viewing area which corresponds to the area on the display surface of a cathode ray tube which is not used to display images. Preferably, the outer perimeter containing the strip of adhesive is located within the non-viewing area of the transparent panel.

The present invention may also be embodied in a cathode ray tube with a transparent panel adhered to the display surface of the cathode ray tube, where the transparent panel includes a strip of adhesive applied around an outer perimeter of the transparent panel and not in a center, viewing portion of the transparent panel, and an anti-reflective coating on the transparent panel. The adhesive adheres the transparent panel to the display surface of the cathode ray tube.

Again, the strip of adhesive preferably covers approximately 15 percent of a surface of the transparent panel and can be made of glass or plastic, preferably glass. The cathode ray tube further includes a non-viewing area on the display surface of the cathode ray tube which is not used to display images. The transparent panel further includes a non-viewing area which corresponds to the non-viewing area of the cathode ray tube, the outer perimeter of the transparent panel containing the strip of adhesive being located within the non-viewing area of the transparent panel.

The present invention also comprises the methods of making and using the items described above. For example, the present invention encompasses a method of applying adhesive to a transparent, anti-reflective panel for application to a display surface of a cathode ray tube by distributing a strip of adhesive around an outer perimeter of the transparent panel and not in a center, viewing portion of the transparent panel. The method continued with adhering the transparent panel to the display surface of the cathode ray tube with the strip of adhesive.

The method may include cleaning the center, viewing portion of the transparent panel before adhering the transparent panel to the display surface of the cathode ray tube.

Finally, there are two preferred methods of distributing the strip of adhesive. The first is spreading the adhesive with a roller. The second includes masking the center, viewing portion of the transparent panel; and spraying adhesive on an exposed periphery of the transparent panel.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is an illustration of a typical cathode ray tube to the manufacture of which the present invention can be profitably applied.

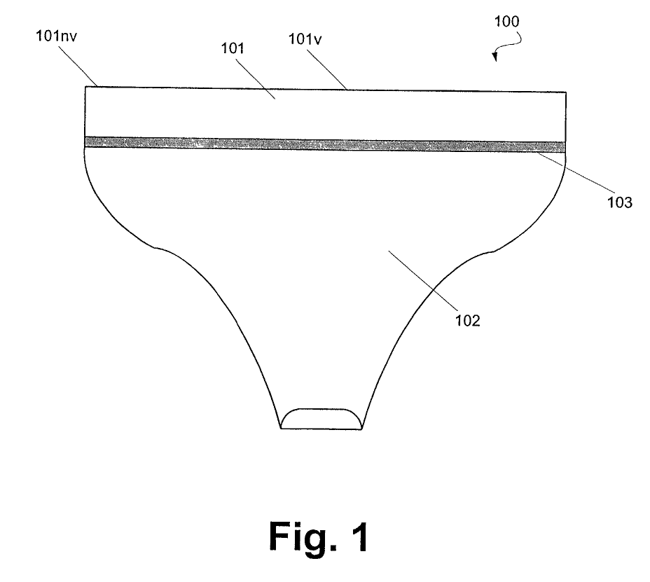

FIG. 2 is an illustration of a transparent panel being applied to the front of a cathode ray tube which application can include the method and systems of the present invention.

FIG. 3 is an illustration of a transparent panel for application to the front of a cathode ray tube, where the transparent panel has been prepared according to the principles of the present invention.

FIG. 4 illustrates a first preferred embodiment of a system for applying adhesive to a transparent panel for the front of a cathode ray tube according to the present invention.

FIG. 5 illustrates a second preferred embodiment of a system for applying adhesive to a transparent panel for the front of a cathode ray tube according to the present invention.

Throughout the drawings, identical elements are designated by identical reference numbers.

### DETAILED DESCRIPTION OF THE PREFERRED EMBODIMENTS

The present invention provides a method and system for applying adhesive to a transparent, anti-reflective panel for a Cathode Ray Tube (“CRT”) where the adhesive is only applied around an outside perimeter of the panel. Preferably, the adhesive is only applied in the outermost perimeter of the panel which corresponds to the outer perimeter of the display surface of the CRT which is beyond the useable area of the display surface, i.e., where no portion of the images displayed extend. Thus, the adhesive will hold the transparent panel to the display surface of the CRT, but will not collect dust and other contaminants that will be trapped over the useable display area of the CRT. Additionally, the panel, with adhesive only around its perimeter, will be relatively easy to remove from the CRT for salvage and reclamation purposes.

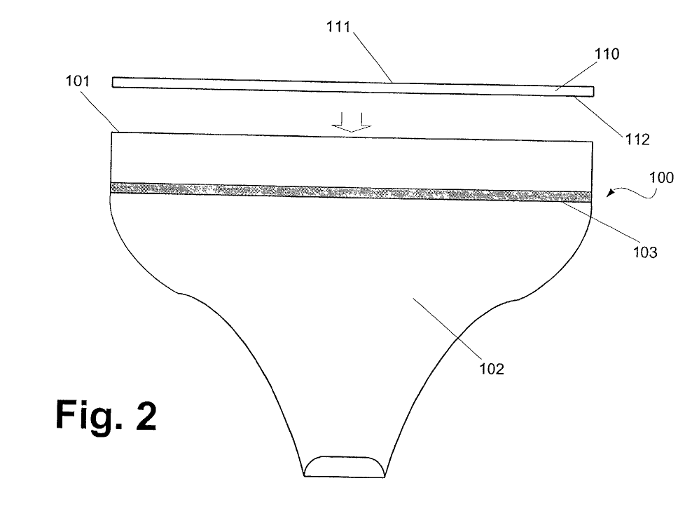

As shown in FIG. 2, to improve the display portion of the CRT (100), a transparent panel (110) is adhered to the display surface (101) of the CRT (100). The panel (110) has an anti-reflective coating (111) applied over an upper or outward surface. When the panel (110) is in place on the CRT (100) and the CRT (100) is being operated to display images, this anti-reflective coating (111) prevents reflections of ambient light by the display surface (101) of the CRT (100) that would otherwise distract a viewer and degrade the images displayed on the surface (101) of the CRT (100).

The transparent panel (110) has traditionally been a transparent plastic panel. Being plastic, such panels have some flexibility. However, according to the principles of the present invention, the transparent panel (110) can be made of any transparent material including both plastic and glass. A glass panel is harder to fit and adhere to the front of the CRT because the glass has no flexibility to accept any defects, curvature or unevenness in the display surface (101). Thus, a glass panel must be made to fit the CRT with some precision. A glass panel can be superior in performance and durability to a plastic panel. While the present invention can be applied to any type of transparent, anti-reflective panel, a glass panel is preferred.

Unlike past methods, the adhesive applied to the transparent panel (110) of the present invention is applied only around an outside perimeter of the panel (110). Preferably, the adhesive is only applied in the outermost perimeter of the panel which corresponds to the outer perimeter of the display surface of the CRT which is beyond the useable area of the display surface, i.e., where no portion of the images displayed extend. Thus, the adhesive will hold the transparent panel to the display surface of the CRT, but will not collect dust and other contaminants that will be trapped over the useable display area of the CRT. Additionally, the panel, with adhesive only around its perimeter, will be relatively easy to remove from the CRT for salvage and reclamation purposes.

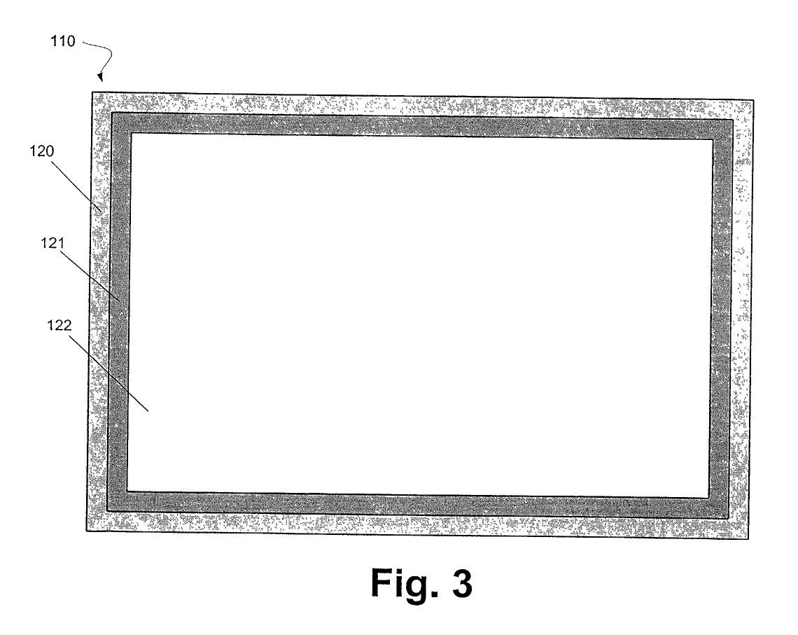

This perimeter adhesive arrangement is illustrated in detail in FIG. 3. As shown in FIG. 3, there are three portions of the transparent panel (110) that are relevant to the present invention. In the center of the panel (110) is the viewing area (122). The viewing area (122) corresponds to the portion of the display surface of a CRT on which the images displayed by the CRT are actually shown, i.e., the usable portion of the CRT display surface. This viewing area (122) of the panel (110) is placed or registered over the usable portion of the CRT display surface when the panel (110) is applied to the CRT. The images on the CRT are viewed through the viewing area (122) of the panel.

The viewing area (122) of the panel (110) is also covered by the anti-reflective coating on the upper or outward surface of the panel (110). As described above, the anti-reflective coating prevents reflection of ambient light from degrading the visibility of images displayed on the CRT and viewed through the viewing area (122) of the transparent panel (110).

Outside and surrounding the viewing portion (122) of the transparent panel (110) is a non-usable area or perimeter (121). This non-usable area (121) extends to the edges of the panel (110) and corresponds with the perimeter of the display surface of the CRT on which no portion of the image displayed extends.

Under the principles of the present invention, a strip of adhesive (120) is applied to the transparent panel (110) only in this non-usable area (121). As shown in FIG. 3, the area of adhesive (120) is preferably in the outer periphery of the non-usable area (121) around the edges of the panel (110). This adhesive (120) is then used to adhere the panel (110) to the display surface of the CRT and can adequately secure the panel (110) to the display surface of the CRT.

With the adhesive (120) being applied only to the outer periphery of the transparent panel (110), the adhesive will not collect dust and other contaminants that will then be trapped between the installed panel (110) and the display surface of a CRT. As noted above, such contaminants degrade the picture quality of images shown on the CRT.

Under the principles of the present invention, the central, usable portion of the panel, the viewing portion (122) can even be cleaned before the panel (110) is adhered to the display surface of a CRT. Thus, the problem with dust and contaminants being trapped by the transparent panel (110) is minimized or eliminated.

An additional advantage of the present invention is as follows. If the panel (110) must be removed from the CRT for salvage or reclamation purposes, the adhesive (120) around the perimeter of the panel (110) can be dissolved or broken with relative ease. The panel (110) can then be removed because it is not further adhered to the CRT by adhesive in the viewing area (122) which would be much more difficult to reach to dissolve or otherwise break the adhesive bond.

Preferably, the adhesive is applied around the perimeter of the transparent panel (110) in a strip with a width such that the strip of adhesive (120) covers 15% of the rear surface area of the transparent panel, i.e., the surface of the panel that is applied against the display surface of the CRT when the panel is installed. It should be noted that the method of the present invention also results in a savings of adhesive as compared with the previous method of covering 100% of the rear surface area of the transparent panel with adhesive.

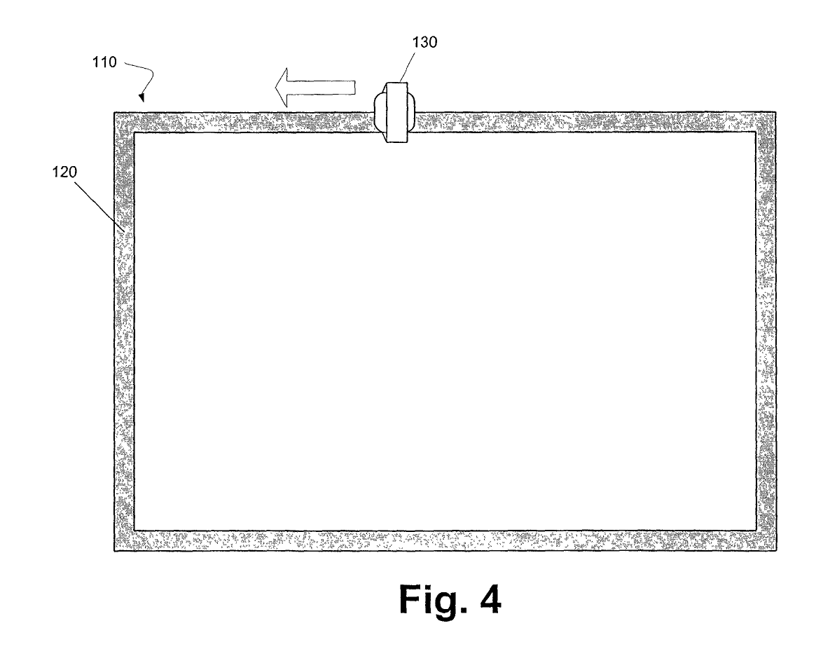

FIG. 4 illustrates a first preferred method of applying the adhesive strip (120) of the present invention around the periphery of the transparent panel (110). As shown in FIG. 4, a roller (130) is rolled around the perimeter of the panel (110) to spread the strip of adhesive (120) described above.

The roller (130) may be periodically dipped in a supply of adhesive which is then applied to the panel (110). Alternatively, the roller (130) may receive a metered flow of adhesive that is dispersed on the surface of the roller (130) or absorbed through a transmissive surface of the roller (130). The roller (130) can be made of any suitable material, whether rigid or flexible, metal, rubber or plastic. The roller (130) can also be made of or incorporate a porous material that will draw and absorb and disperse a liquid adhesive.

The roller (130) may be operated by a technician. Alternatively, there may be an automated robotic system for supplying the roller (130) with adhesive and moving the roller (130) around the perimeter of the transparent panel (110).

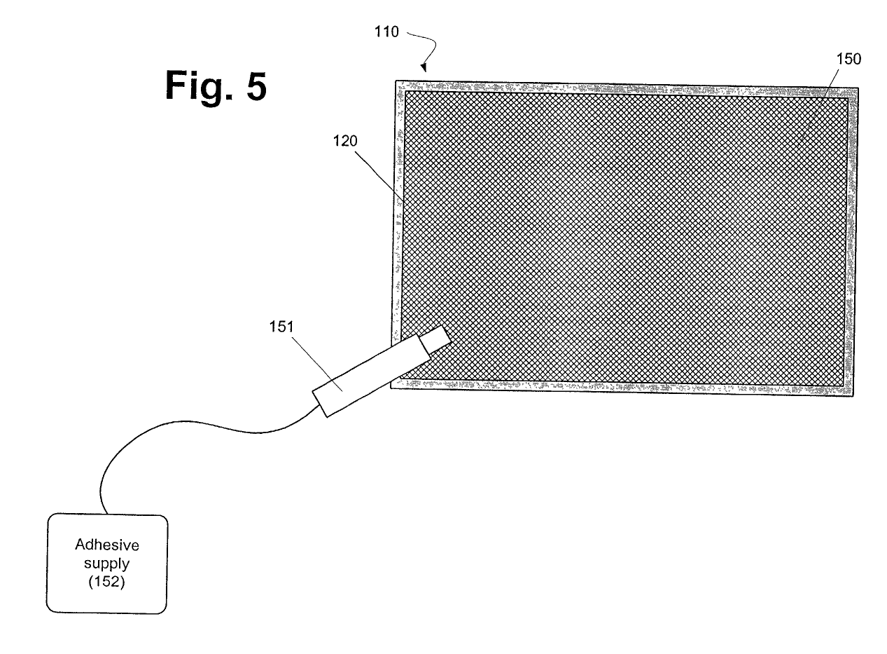

FIG. 5 illustrates a second preferred method of preparing the transparent panel (110) of the present invention with a perimeter strip of adhesive (120). As shown in FIG. 5, a mask (150) may be placed or registered over that central portion of the transparent panel (110) where the adhesive is not to be applied. A spray system (151) then sprays adhesive over the masked panel (110). The mask (150) is then removed leaving the desired strip of adhesive (120) around the periphery.

The spray system preferably includes one or more nozzles (151) from which adhesive is sprayed. This nozzle or nozzles may be positioned to spray adhesive over the entire panel (110) from a single location or may be moved, manually or robotically, to spray adhesive over the periphery of the panel (110). A supply of adhesive (152) is fed or pumped under sufficient pressure to the nozzle assembly (151) to spray adhesive evenly over the perimeter of the panel (110).

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A transparent panel for application to a display surface of a cathode ray tube, said transparent panel comprising a strip of adhesive applied around an outer perimeter of said transparent panel and not in a center, viewing portion of said transparent panel.

2. The transparent panel of claim 1, wherein said strip of adhesive covers approximately 15 percent of a surface of said transparent panel.

3. The transparent panel of claim 1, wherein said transparent panel is glass.

4. The transparent panel of claim 1, wherein said transparent panel is plastic.

5. The transparent panel of claim 1, wherein said transparent panel further comprises a non-viewing area which corresponds to an area on a display surface of a cathode ray tube which is not used to display images, said outer perimeter containing said strip of adhesive being located within said non-viewing area of said transparent panel.

6. A cathode ray tube comprising a transparent panel adhered to a display surface of said cathode ray tube, said transparent panel comprising:
a strip of adhesive applied around an outer perimeter of said transparent panel and not in a center, viewing portion of said transparent panel, said adhesive adhering said transparent panel to said display surface of said cathode ray tube; and
an anti-reflective coating on said transparent panel.

7. The cathode ray tube of claim 6, wherein said strip of adhesive covers approximately 15 percent of a surface of said transparent panel.

8. The cathode ray tube of claim 6, wherein said transparent panel is glass.

9. The cathode ray tube of claim 6, wherein said transparent panel is plastic.

10. The cathode ray tube of claim 6, wherein:
said cathode ray tube further comprises a non-viewing area on said display surface of said cathode ray tube which is not used to display images; and
said transparent panel further comprises a non-viewing area which corresponds to said non-viewing area of said cathode ray tube, said outer perimeter containing said strip of adhesive being located within said non-viewing area of said transparent panel.

11. A method of applying adhesive to a transparent, anti-reflective panel for application to a display surface of a cathode ray tube, said method comprising distributing a strip of adhesive around an outer perimeter of said transparent panel and not in a center, viewing portion of said transparent panel.

12. The method of claim 11, further comprising adhering said transparent panel to said display surface of said cathode ray tube with said strip of adhesive.

13. The method of claim 12, further comprising cleaning said center, viewing portion of said transparent panel prior to said adhering said transparent panel to said display surface of said cathode ray tube.

14. The method of claim 11, wherein said strip of adhesive covers approximately 15 percent of a surface of said transparent panel.

15. The method of claim 11, wherein said transparent panel is glass.

16. The method of claim 11, wherein said transparent panel is plastic.

17. The cathode ray tube of claim 11, wherein:
said cathode ray tube further comprises a non-viewing area on said display surface of said cathode ray tube which is not used to display images;
said transparent panel further comprises a non-viewing area which corresponds to said non-viewing area of said cathode ray tube; and
said distributing said strip of adhesive further comprises distributing said strip of adhesive in said non-viewing area of said transparent panel.

18. The method of claim 11, wherein said distributing said strip of adhesive further comprises spreading said adhesive with a roller.

19. The method of claim 11, wherein said distributing said strip of adhesive further comprises:
masking said center, viewing portion of said transparent panel; and
spraying adhesive on an exposed periphery of said transparent panel.

20. An anti-reflective, transparent panel for application to a display surface of a cathode ray tube, said transparent panel comprising:
means for minimizing reflection of ambient light; and
means for securing said transparent panel to said display surface of a cathode ray tube, said means for securing being disposed around an outer perimeter of said transparent panel and not in a center, viewing portion of said transparent panel.
